(19) United States
(12) Patent Application Publication
(10) Pub. No.: US 2015/0188196 A1
(43) Pub. Date: Jul. 2, 2015

(54) NON-AQUEOUS ELECTROLYTIC SECONDARY BATTERY

(71) Applicant: SANYO Electric Co., Ltd., Osaka (JP)

(72) Inventors: Keisuke MINAMI, Kakogawa-shi (JP); Toyoki FUJIHARA, Kanzaki-gun (JP)

(21) Appl. No.: 14/582,961

(22) Filed: Dec. 24, 2014

(30) Foreign Application Priority Data
Dec. 26, 2013 (JP) 2013-268672

(51) Int. Cl. H01M 10/0587; H01M 2/04; H01M 10/0567; H01M 2/02; H01M 10/0525; H01M 10/04

(52) U.S. Cl. CPC H01M 10/0587; H01M 10/0525; H01M 10/0431; H01M 10/0567; H01M 2/0217; H01M 2/043; H01M 2/0237; H01M 2220/20; H01M 2300/0025

(57) ABSTRACT

A non-aqueous electrolytic secondary battery is provided having a flat-shaped winding electrode assembly having a positive electrode plate and a negative electrode plate, a non-aqueous electrolyte, and a rectangular outer housing that houses the winding electrode assembly and the non-aqueous electrolyte, wherein the non-aqueous electrolyte includes lithium fluorosulfonic acid, the rectangular outer housing has a pair of large-area side walls and a pair of small-area side walls, and a value of a number of layers of the positive electrode plate in the winding electrode assembly placed between the pair of the large-area side walls with respect to a distance between the pair of the large-area side walls is greater than or equal to 5 layers/mm.

### PRIORITY INFORMATION

This application claims priority to Japanese Patent Application No. 2013-268672, filed on Dec. 26, 2013, which is incorporated herein by reference in its entirety.

### BACKGROUND

1. Technical Field

The present invention relates to a non-aqueous electrolytic secondary battery.

2. Related Art

In recent years, a non-aqueous electrolytic secondary battery having a high energy density is used for a driving power supply or the like for a hybrid electric vehicle (PHEV, HEV), or an electric vehicle. A demand for higher performance is growing higher for the non-aqueous electrolytic secondary battery used for the driving power supply or the like.

JP 2013-152956 A discloses, as a technique for providing a non-aqueous electrolytic secondary battery in which an initial charge/discharge capacity, an input/output characteristic, and an impedance characteristic are improved, a technique for including fluorosulfonic acid salt in the non-aqueous electrolyte, and also including a particular compound.

According to the technique disclosed in JP 2013-152956 A, although a non-aqueous electrolytic secondary battery having a superior battery characteristic can be obtained, a further improvement of the battery characteristic is desired. An advantage of the present invention is that a non-aqueous electrolytic secondary battery is provided having an improved battery characteristic, in particular, having a superior power characteristic and a superior high-temperature storage characteristic.

### SUMMARY

According to one aspect of the present invention, there is provided a non-aqueous electrolytic secondary battery comprising: a flat-shaped electrode assembly having a positive electrode plate including a lithium transition metal complex oxide as a positive electrode active material, and a negative electrode plate including a negative electrode active material to and from which lithium ions may be introduced and extracted; a non-aqueous electrolyte; a rectangular outer housing that has a tubular shape with a bottom, that has an opening, and that houses the electrode assembly and the non-aqueous electrolyte; and a sealing plate that seals the opening, wherein the non-aqueous electrolyte includes lithium fluorosulfonic acid, the rectangular outer housing comprises a pair of large-area side walls and a pair of small-area side walls having a smaller area than the large-area side wall, and a value of a number of layers of the positive electrode plate in the electrode assembly placed between the pair of the large-area side walls with respect to a distance between the pair of the large-area side walls is greater than or equal to 5 layers/mm.

According to another aspect of the present invention, preferably, the electrode assembly is a winding electrode assembly in which the positive electrode plate and the negative electrode plate are wound with a separator therebetween.

According to another aspect of the present invention, preferably, a ratio of a total thickness of the negative electrode plate in the electrode assembly placed between the pair of the large-area side walls with respect to a total thickness of the positive electrode plate in the electrode assembly placed between the pair of the large-area side walls is 100%˜120%.

According to another aspect of the present invention, preferably, a ratio of a total thickness of the separator in the electrode assembly placed between the pair of the large-area side walls with respect to a total thickness of the positive electrode plate in the electrode assembly placed between the pair of the large-area side walls is 65%˜85%.

### Advantageous Effects

According to various aspects of the present invention, a non-aqueous electrolytic secondary battery is provided in which the non-aqueous electrolyte includes lithium fluorosulfonic acid (FSO₃Li), and having a superior power characteristic and a superior high-temperature storage characteristic by having a number of layers of the positive electrode plate with respect to a distance between a pair of large-area side walls of an outer housing of greater than or equal to 5 layers/mm.

### BRIEF DESCRIPTION OF THE DRAWINGS

FIG. 1 is a perspective diagram of a non-aqueous electrolytic secondary battery according to a preferred embodiment of the present invention.

FIG. 2A is a cross sectional diagram along a line IIA-IIA of FIG. 1.

FIG. 2B is a cross sectional diagram along a line IIB-IIB of FIG. 2A.

FIG. 3A is a plan view of a positive electrode plate used in the non-aqueous electrolytic secondary battery according to a preferred embodiment of the present invention.

FIG. 3B is a cross sectional diagram along a line IIIB-IIIB of FIG. 3A.

FIG. 4A is a plan view of a negative electrode plate used in the non-aqueous electrolytic secondary battery according to a preferred embodiment of the present invention.

FIG. 4B is a cross sectional diagram along a line IVB-IVB of FIG. 4A.

FIG. 5 is a cross sectional diagram along a line IV-IV of FIG. 2A.

### DESCRIPTION OF EXEMPLARY EMBODIMENTS

A preferred embodiment of the present invention will now be described in detail. The preferred embodiment(s) described below is merely exemplary for understanding of the technical idea of the present invention, and is not intended to limit the present invention to the particular embodiment(s) described herein.

As shown in FIG. 2, a non-aqueous electrolytic secondary battery has a flat-shaped winding electrode assembly 4 in which a positive electrode plate 1 and a negative electrode plate 2 are wound with a separator 3 therebetween. The outermost circumferential surface of the flat-shaped winding electrode assembly 4 is covered by the separator 3.

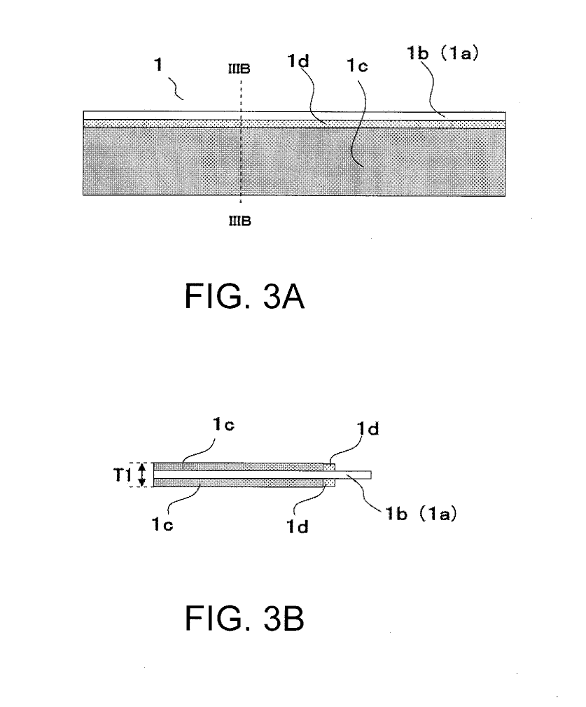

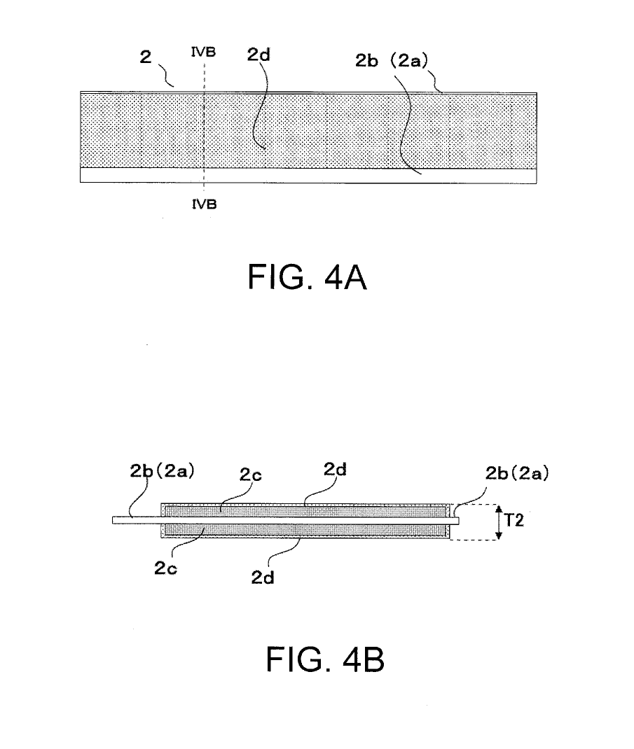

As shown in FIG. 3, in the positive electrode plate 1, a positive electrode mixture layer 1c is formed over both surfaces of a positive electrode core 1a made of aluminum or an aluminum alloy such that positive electrode core exposed portions 1b where a core is exposed in a band shape along a longitudinal direction at an end of one side in a width direction are formed over both surfaces. Over the positive electrode core 1a near the end of the positive electrode mixture layer 1c, a positive electrode protection layer 1d is formed. As shown in FIG. 4, in the negative electrode plate 2, a negative electrode mixture layer 2c is formed over both surfaces of a negative electrode core 2a made of copper or a copper alloy such that negative electrode core exposed portions 2b where a core is exposed in a band shape along a longitudinal direction on both ends in a width direction are formed over both surfaces. A negative electrode protection layer 2d is formed over the negative electrode mixture layer 2c. A width of the negative electrode core exposed portion 2b provided on one end in the width direction of the negative electrode plate 2 is wider than a width of the negative electrode core exposed portion 2b provided on the other end in the width direction of the negative electrode plate 2. Alternatively, the negative electrode core exposed portion 2b may be provided on only one end in the width direction of the negative electrode plate 2.

The positive electrode plate 1 and the negative electrode plate 2 are wound with the separator 3 therebetween, and formed in a flat shape, so that the flat-shaped winding electrode assembly 4 is produced. In this process, the positive electrode core exposed portion 1b which is wound is formed on one end of the flat-shaped winding electrode assembly 4, and the negative electrode core exposed portion 2b which is wound is formed on the other end.

As shown in FIG. 2, the wound positive electrode core exposed portion 1b is electrically connected to a positive electrode terminal 6 via a positive electrode electricity collector 5. The wound negative electrode core exposed portion 2b is electrically connected to a negative electrode terminal 8 via a negative electrode electricity collector 7. The positive electrode electricity collector 5 and the positive electrode terminal 6 are preferably made of aluminum or an aluminum alloy. The negative electrode electricity collector 7 and the negative electrode terminal 8 are preferably made of copper or a copper alloy. The positive electrode terminal 6 preferably includes a connection section 6a penetrating through a sealing plate 11 made of a metal, a plate-shaped section 6b placed on an outer surface side of the sealing plate 11, and a bolt section 6c provided over the plate-shaped section 6b. The negative electrode terminal 8 preferably includes a connection section 8a penetrating through the sealing plate 11, a plate-shaped section 8b placed at an outer surface side of the sealing plate 11, and a bolt section 8c provided over the plate-shaped section 8b.

On an electricity conduction path between the positive electrode plate 1 and the positive electrode terminal 6, a current disconnection mechanism 16 is provided which is activated when an inner pressure of the battery becomes larger than a predetermined value to disconnect the electricity conduction path between the positive electrode plate 1 and the positive electrode terminal 6.

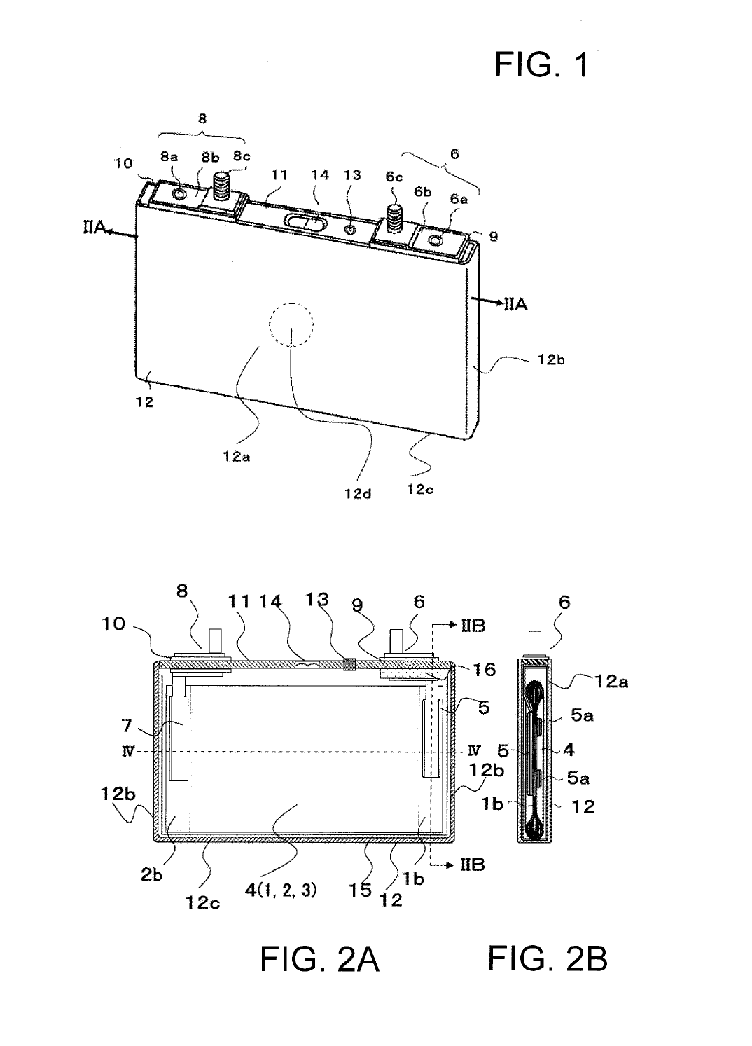

As shown in FIGS. 1 and 2A, the positive electrode terminal 6 is fixed on the sealing plate 11 with an insulating member 9 therebetween. The negative electrode terminal 8 is fixed on the sealing plate 11 with an insulating member 10 therebetween.

The flat-shaped winding electrode assembly 4 is housed in a rectangular outer housing 12 in a state of being covered with an insulating sheet 15 made of a resin. The sealing plate 11 is contacted to an opening of the rectangular outer housing 12 made of a metal, and the contact section between the sealing plate 11 and the rectangular outer housing 12 is laser-welded.

The rectangular outer housing 12 has a tubular shape with a bottom, and includes a pair of large-area side walls 12a, a pair of small-area side walls 12b having a smaller area than the large-area side walls 12a, and a bottom 12c. On a flat section of the flat-shaped winding electrode assembly 4, a pair of flat outer surfaces are placed to oppose the pair of the large-area side walls 12a, respectively.

The sealing plate 11 has an electrolytic solution injection hole 13, a non-aqueous electrolytic solution is introduced through the electrolytic solution injection hole 13, and then, the electrolytic solution injection hole 13 is sealed by a blind rivet or the like. On the sealing plate 11, a gas discharge valve 14 is formed which breaks when an inner pressure of the battery becomes a larger value than an activation pressure of the current disconnection mechanism 16 to discharge the gas inside the battery to the outside of the battery.

Next, manufacturing methods of the positive electrode plate 1, the negative electrode plate 2, the flat-shaped winding electrode assembly 4, and non-aqueous electrolytic solution serving as the non-aqueous electrolyte in the non-aqueous electrolytic secondary battery will be described.

### [Production of Positive Electrode Plate]

As the positive electrode active material, a lithium transition metal complex oxide represented by Li(Ni_{0.35}Co_{0.35}Mn_{0.30})_{0.95}Zr_{0.05}O₂ was used. The positive electrode active material, a carbon powder serving as an electricity conducting agent, and polyvinylidene fluoride (PVdF) serving as a binding agent were prepared in an amount in mass ratio of 91:7:2, and were mixed with N-methyl-2-pyrrolidone (NMP) serving as a dispersing medium, to produce a positive electrode mixture slurry.

An alumina powder, the PVdF, a carbon powder, and the NMP serving as the dispersing medium were mixed in an amount in mass ratio of 21:4:1:74, to produce a positive electrode protection layer slurry.

The positive electrode mixture slurry produced by the above-described method was applied on both surfaces of an aluminum foil serving as the positive electrode core 1a by a die coater. Then, the positive electrode protection layer slurry produced by the above-described method was applied over the positive electrode core 1a at an end of the region in which the positive electrode mixture slurry was applied. Then, the electrode plate was dried to remove the NMP serving as the dispersing medium, and the structure was compressed by a roll press to a predetermined thickness. The resulting structure was cut in a predetermined size such that the positive electrode core exposed portion 1b where the positive electrode mixture layer 1c was not formed on both surfaces along a longitudinal direction was formed on one end in a width direction of the positive electrode plate 1, to form the positive electrode plate 1. An area in a plan view of the positive electrode core 1a where the positive electrode mixture layer 1c was formed on both surfaces was 0.42 m². A thickness of the positive electrode protection layer 1d was set lower than a thickness of the positive electrode mixture layer 1c.

### [Production of Negative Electrode Plate]

A graphite powder serving as the negative electrode active material, carboxymethyl cellulose (CMC) serving as a viscosity enhancing agent, and styrene-butadiene rubber (SBR) serving as a binding agent were dispersed in water in an amount in mass ratio of 98:1:1, to produce a negative electrode mixture slurry.

An alumina powder, a binding agent (acrylic resin), and the NMP serving as a dispersing medium were mixed in an amount in mass ratio of 30:0.9:69.1, to produce a negative electrode protection layer slurry to which a mixture dispersion process was applied by a bead mill.

The negative electrode mixture slurry produced by the above-described method was applied to both surfaces of a copper foil serving as the negative electrode core 2a by a die coater. Then, the structure was dried to remove the water serving as the dispersing medium, and was compressed by a roll press to a predetermined thickness. Then, the negative electrode protection layer slurry produced by the above-described method was applied over the negative electrode mixture layer 2c, and the NMP used as a solvent was dried and removed, to produce the negative electrode protection layer 2d. Then, the structure was cut in a predetermined size such that the negative electrode core exposed portion 2b where the negative electrode mixture layer 2c was not formed on both surfaces along a longitudinal direction was formed on both ends in a width direction of the negative electrode plate, to produce the negative electrode plate 2. An area in the plan view of the negative electrode core 2a where the negative electrode mixture layer 2c was formed on both surfaces was 0.44 m².

### [Production of Flat-Shaped Winding Electrode Assembly]

The positive electrode plate 1 and the negative electrode plate 2 produced by the above-described methods were wound with the separator 3 made of polypropylene and having a thickness of 20 μm therebetween, and then press-molded in a flat shape to produce the flat-shaped winding electrode assembly 4. This process was executed in a manner such that, on one end in a winding axis direction of the flat-shaped winding electrode assembly 4, the wound positive electrode core exposed portion 1b was formed, and on the other end, the negative electrode core exposed portion 2b was formed. The separator 3 was positioned at the outermost circumference of the flat-shaped winding electrode assembly 4. In addition, a winding termination end of the negative electrode plate 2 was positioned at a more outer circumferential side than a winding termination end of the positive electrode plate 1.

Here, in the flat-shaped winding electrode assembly 4, a thickness T1 of the positive electrode plate 1 was 58 μm, a thickness of the positive electrode core 1a was 15 μm, and a thickness of the positive electrode mixture layer 1c was 43 μm (21.5 μm on each side). A filling density of the positive electrode mixture layer was 2.47 g/cm³. In the flat-shaped winding electrode assembly 4, a thickness T2 of the negative electrode plate 2 was 60 μm, a thickness of the negative electrode core 2a was 8 μm, a thickness of the negative electrode mixture layer 2c was 48 μm (24 μm on each side), and a thickness of the negative electrode protection layer 2d was 4 μm (2 μm on each side). A filling density of the negative electrode mixture layer was 1.13 g/cm³. The thicknesses related to the positive electrode plate 1 and the negative electrode plate 2 refer to values at the flat section (portion placed between a center section 12d of one large-area side wall 12a and a center section 12d of the other large-area side wall 12a) of the flat-shaped winding electrode assembly 4.

### [Preparation of Non-Aqueous Electrolytic Solution]

A mixture solvent was produced in which ethylene carbonate (EC), ethylmethyl carbonate (EMC), and diethyl carbonate (DEC) were mixed in a volume ratio (25° C., 1 atmosphere) of 3:3:4. To this mixture solvent, LiPF₆ was added to a concentration of 1 mol/L, and then 0.3 weight %, with respect to the total mass of the non-aqueous electrolyte, of vinylene carbonate (VC) and 1.0 weight % of lithium fluorosulfonic acid were added, to produce a non-aqueous electrolytic solution.

### [Assembly of Non-Aqueous Electrolytic Secondary Battery]

The positive electrode terminal 6 and the positive electrode electricity collector 5 were electrically connected, and were fixed on the sealing plate 11 made of aluminum with the insulating member 9 therebetween. In addition, the current disconnection mechanism 16 that disconnects the electricity conduction path between the positive electrode terminal 6 and the positive electrode electricity collector 5 with an increase of an internal pressure of the battery was provided between the positive electrode terminal 6 and the positive electrode electricity collector 5. The negative electrode terminal 8 and the negative electrode electricity collector 7 were electrically connected, and were fixed on the sealing plate 11 with the insulating member 10 therebetween. Then, the positive electrode electricity collector 5 and a mounting component 5a were connected to the outermost surface of the wound positive electrode core exposed portion 1b, and the negative electrode electricity collector 7 and a mounting component were connected to the outermost surface of the negative electrode core exposed portion 2b.

Then, the flat-shaped winding electrode assembly 4 was covered with the insulating sheet 15 made of polypropylene and folded and molded in a box shape, and the resulting structure was inserted into the rectangular outer housing 12 made of aluminum. The contact section between the rectangular outer housing 12 and the sealing plate 11 were laser-welded, to seal the opening of the rectangular outer housing 12.

After the non-aqueous electrolytic solution produced by the above-described method was introduced from the electrolytic solution injection hole 13 of the sealing plate 11, the electrolytic solution injection hole 13 was sealed with a blind rivet. The non-aqueous electrolytic secondary battery of the present embodiment was set as a battery I.

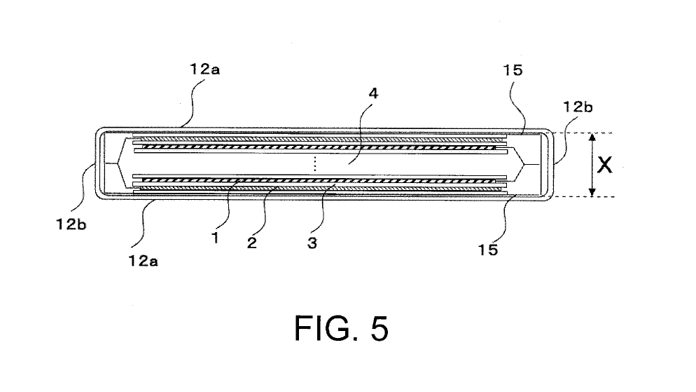

As shown in FIG. 5, in the battery I, a distance X between the pair of the large-area side walls 12a of the rectangular outer housing 12 was 12.5 mm, a number of layers Y of the positive electrode plate 1 in the flat-shaped winding electrode assembly 4 placed between the pair of the large-area side walls 12a of the rectangular outer housing 12 was 68 layers, and Y/X was 5.4 layers/mm. A thickness of a portion, of the flat-shaped winding electrode assembly 4, placed between the center section 12d of one large-area side wall 12a and the center section 12d of the other large-area side wall 12a was 11.1 mm. The distance X between the pair of the large-area side walls 12a refers to a distance between the center section 12d of one large-area side wall 12a and the center section 12d of the other large-area side wall 12a. The number of layers Y of the positive electrode plate 1 in the flat-shaped winding electrode assembly 4 placed between the pair of the large-area side walls 12a refers to the number of layers of the positive electrode plate 1 existing between the center section 12d of one large-area side wall 12a and the center section 12d of the other large-area side wall 12a.

In the battery I, a ratio of a total thickness (4.20 mm) of the negative electrode plate 2 in the flat-shaped winding electrode assembly 4 placed between the pair of the large-area side walls 12a of the rectangular outer housing 12 with respect to a total thickness (3.94 mm) of the positive electrode plate 1 in the flat-shaped winding electrode assembly 4 placed between the pair of the large-area side walls 12a of the rectangular outer housing 12 was 107%. In addition, in the battery I, a ratio of a total thickness (2.96 mm) of the separator 3 in the flat-shaped winding electrode assembly 4 placed between the pair of the large-area side walls 12a of the rectangular outer housing 12 with respect to a total thickness (3.94 mm) of the positive electrode plate 1 in the flat-shaped winding electrode assembly 4 placed between the pair of the large-area side walls 12a of the rectangular outer housing 12 was 75%. The total thickness of the positive electrode plate 1, the total thickness of the negative electrode plate 2, and the total thickness of the separator 3 in the flat-shaped winding electrode assembly 4 placed between the pair of the large-area side walls 12a of the rectangular outer housing 12 are respectively the total thicknesses of the positive electrode plate 1, the negative electrode plate 2, and the separator 3 existing between the center section 12d of one large-area side wall 12a and the center section 12d of the other large-area side wall 12a.

A non-aqueous electrolytic secondary battery having a similar structure to that of the battery I except that lithium fluorosulfonic acid was not added to the non-aqueous electrolyte was produced and set as a battery II.

For the battery I and the battery II produced by the above-described methods, an initial normal temperature resistance, a battery expansion rate, and an after-storage capacity maintenance ratio were measured in the following manner.

### [Measurement of Initial Normal Temperature Resistance]

The battery was charged to a state of charge (SOC) of 56% at a constant current of 1 C under a condition of 25° C. The battery was then discharged for 10 seconds at a constant current of 45 C and a temperature of 25° C., a graph was plotted with voltages before and after the discharge on the y-axis and the current value on the x-axis, and a slope thereof was set as the initial normal temperature resistance.

### [Measurement of Battery Expansion Rate]

After the battery was charged to a SOC of 80% at a constant current of 1 C and a temperature of 25° C., a thickness of the center section of the battery was measured and set as a before-storage battery thickness. Then, the battery was stored for 1 week at 60° C. After the storage, the thickness of the center section of the battery was measured and set as an after-storage battery thickness. A battery expansion rate was calculated from the following equation:

Battery expansion rate(%)=after-storage battery thickness/before-storage battery thickness×100

### [Measurement of After-Storage Capacity Maintenance Ratio]

The battery was charged to 4.1 V at a constant current of 1 C and a temperature of 25° C. After the battery was charged for 2 hours at 4.1 V, the battery was discharged to 3 V at a constant current of ½ C, and was discharged for 3 hours at 3 V. The discharge capacity in this process was set as a before-storage capacity.

Then, the battery was charged to an SOC of 80% at a constant current of 1 C, and stored for 40 days at 60° C. After the storage, the battery was charged to 4.1 V at a constant current of 1 C. After the battery was charged for 2 hours at 4.1 V, the battery was discharged to 3 V at a constant current of ½ C, and discharged for 3 hours at 3 V. A discharge capacity in this process was set as an after-storage capacity. An after-storage capacity maintenance ratio was calculated by the following equation:

After-storage capacity maintenance ratio(%)=after-storage capacity/before-storage capacity×100

TABLE 1 shows results of the above-described measurements. With regard to the initial normal temperature resistance, the measured value for the battery I was set as 100%, and a relative value for the measured value for the battery II with respect to the measured value of the battery I is shown.

TABLE 1

| | AMOUNT | | | AFTER-STORAGE |
|---|---|---|---|---|
| | OF ADDED | INITIAL NORMAL | BATTERY | CAPACITY |
| | FSO₃Li | TEMPERATURE | EXPANSION | MAINTENANCE |
| | (WEIGHT %) | RESISTANCE (%) | RATE (%) | RATIO (%) |
| BATTERY I | 1.0 | 100 | 118 | 92 |
| BATTERY II | — | 106 | 126 | 89 |

As shown in TABLE 1, by including lithium fluorosulfonic acid in the non-aqueous electrolyte and setting the number of layers of the positive electrode plate with respect to the distance between the pair of the large-area side walls of the outer housing to greater than or equal to 5 layers/mm, it is possible to obtain a non-aqueous electrolytic secondary battery having a superior high-temperature storage characteristic and a low resistance, that is, a superior power characteristic.

The content of lithium fluorosulfonic acid in the non-aqueous electrolyte is not particularly limited, but is preferably 0.1˜2.0 weight %, and more preferably, 0.5˜1.5 weight %. In addition, the number of layers of the positive electrode plate with respect to the distance between the pair of the large-area side walls of the outer housing is preferably set to less than or equal to 8 layers/mm, and more preferably set to less than or equal to 7 layers/mm.

A battery III and a battery IV were produced by a method similar to the above-described method for the battery I, except that the content of lithium fluorosulfonic acid in the non-aqueous electrolyte with respect to the total mass of the non-aqueous electrolyte was set to 2 weight % and 4 weight %, respectively. For the batteries III and IV, the initial normal temperature resistance was measured by the above-described method. In addition, the after-storage capacity maintenance ratio was measured by a method similar to the above-described method, except that the storage period at 60° C. was changed from 40 days to 20 days. TABLE 2 shows the results. With regard to the initial normal temperature resistance, the measured value for the battery I was set as 100%, and relative values for the measured values for the batteries III and IV with respect to the measured value for the battery I are shown.

TABLE 2

| | | | AFTER- |
|---|---|---|---|
| | AMOUNT | | STORAGE |
| | OF ADDED | INITIAL NORMAL | CAPACITY |
| | FSO₃Li | TEMPERATURE | MAINTENANCE |
| | (WEIGHT %) | RESISTANCE (%) | RATIO (%) |
| BATTERY III | 2.0 | 95.5 | 94.9 |
| BATTERY IV | 4.0 | 100.0 | 93.0 |

The batteries III and IV using non-aqueous electrolyte including FSO₃Li may be expected to have a higher capacity maintenance ratio after storage at a high temperature than a battery which uses non-aqueous electrolyte which does not include FSO₃Li.

A battery V was produced through a method similar to that for the battery I except that the content of lithium fluorosulfonic acid in the non-aqueous electrolyte with respect to the total mass of the non-aqueous electrolyte was set to 0.5 weight %. For the batteries V, I, and III, the after-storage capacity maintenance ratio was measured by a method similar to the above except that the storage period at 60° C. was changed from 40 days to 180 days. In addition, after-storage normal temperature discharge resistance/normal temperature resistance increase ratios (25° C., SOC of 56%) were measured and after-storage low temperature resistance/low temperature resistance increase ratios (−30° C., SOC of 56%) were measured through the following methods.

### [Measurement of After-Storage Normal Temperature Discharge Resistance/Normal Temperature Resistance Increase Ratio (25° C., SOC of 56%)]

The battery was charged to 4.1 V at a constant current of 1 C and a temperature of 25° C. After the battery was charged for 2 hours at 4.1 V, the battery was discharged to 3 V at a constant current of ½ C, and discharged for 3 hours at 3 V. The battery was then charged to a state of charge (SOC) of 56% at a constant current of 1 C and a temperature of 25° C. Then, the battery was discharged for 10 seconds at a constant current of 45 C and a temperature of 25° C., a graph was plotted with the voltages before and after the discharge on the y-axis and the current on the x-axis, and a slope thereof was set as a before-storage normal temperature resistance. Then, the battery was charged to a SOC of 80% at a constant current of 1 C, and was stored for 180 days at 60° C. After the storage, the battery was discharged to 3 Vat a constant current of ½ C and a temperature of 25° C., discharged for 3 hours at 3 V, and then charged to a state of charge (SOC) of 56% at a constant current of 1 C. Then, the battery was discharged for 10 seconds at a constant current of 45 C and a temperature of 25° C., a graph was plotted with the voltages before and after the discharge on the y-axis and the current on the x-axis, and a slope thereof was set as an after-storage normal temperature resistance. In addition, a ratio of the after-storage normal temperature resistance with respect to the before-storage normal temperature resistance was set as a normal temperature resistance increase ratio.

### [Measurement of After-Storage Low Temperature Resistance/Low Temperature Resistance Increase Ratio (−30° C., SOC of 56%)]

The battery was charged to 4.1 V at a constant current of 1 C and a temperature of 25° C. After the battery was charged at 4.1 V for 2 hours, the battery was discharged to 3 V at a constant current of ½ C and discharged for 3 hours at 3 V. Then the battery was charged to a state of charge (SOC) of 56% at a constant current of 1 C and a temperature of 25° C. The battery was then discharged for 10 seconds at a constant current of 15 C and a temperature of −30° C., a graph was plotted with the voltages before and after the discharge on the y-axis and the current on the x-axis, and a slope thereof was set as a before-storage low temperature resistance. Then, the battery was charged to a SOC of 80% at a constant current of 1 C, and stored for 180 days at 60° C. After the storage, the battery was discharged to 3 Vat a constant current of ½ C and a temperature of 25° C., discharged for 3 hours at 3 V, and then charged to a state of charge (SOC) of 56% at a constant current of 1 C. Then, the battery was discharged for 10 seconds at a constant current of 15 C and a temperature of −30° C., a graph was plotted with the voltages before and after the discharge on the y-axis and the current on the x-axis, and a slope thereof was set as an after-storage low temperature resistance. A ratio of the after-storage low temperature resistance with respect to the before-storage low temperature resistance was set as the low temperature resistance increase ratio.

TABLE 3 shows results of the measurements of the after-storage capacity maintenance ratio, the after-storage normal temperature resistance/normal temperature resistance increase ratio (25° C., SOC of 56%), and the after-storage low temperature resistance/low temperature resistance increase ratio (−30° C., SOC of 56%). With regard to the low temperature resistance, the measured value for the battery I was set as 100%, and relative values of the measured values for the batteries V and III with respect to the measured value for the battery I are shown.

TABLE 3

| | | | 25° C. SOC56% | | −30° C. SOC56% | |
|---|---|---|---|---|---|---|
| | | | | NORMAL | | LOW |
| | AMOUNT OF | AFTER-STORAGE | NORMAL | TEMPERATURE | LOW | TEMPERATURE |
| | ADDED | CAPACITY | TEMPERATURE | RESISTANCE | TEMPERATURE | RESISTANCE |
| | FSO₃Li | MAINTENANCE | RESISTANCE | INCREASE | RESISTANCE | INCREASE |
| | (WEIGHT %) | RATIO (%) | (%) | RATIO (%) | (%) | RATIO (%) |
| BATTERY V | 0.5 | 84 | 105 | 108 | 109 | 90 |
| BATTERY I | 1.0 | 86 | 100 | 107 | 100 | 85 |
| BATTERY III | 2.0 | 85 | 102 | 105 | 98 | 83 |

It can be expected that the batteries V, I, and III which use the non-aqueous electrolyte including FSO₃Li have a higher capacity maintenance ratio after high-temperature storage, and a lower increase of resistance due to the high-temperature storage compared to a battery which uses non-aqueous electrolyte which does not include FSO₃Li.

### <Others>

As the positive electrode active material, lithium transition metal complex oxides may be exemplified such as lithium cobalt oxide (LiCoO₂), lithium manganate (LiMn₂O₄), lithium nickel oxide (LiNiO₂), lithium nickel manganese complex oxide (LiNi₁₋ₓMnₓO₂ (0<x<1)), lithium nickel cobalt complex oxide (LiNi₁₋ₓCoₓO₂ (0<x<1)), and lithium nickel cobalt manganese complex oxide (LiNiₓCo_{y}Mn_{z}O₂ (0<x<1, 0<y<1, 0<z<1, x+y+z=1)). In addition, the above-described lithium transition metal complex oxide doped with Al, Ti, Zr, Nb, B, W, Mg, or Mo or the like may alternatively be used. For example, lithium transition metal complex oxide may be exemplified represented by Li₁₊ₐNiₓCo_{y}Mn_{z}M_{b}O₂ (M=at least one element selected from Al, Ti, Zr, Nb, B, Mg, and Mo, 0≦a≦0.2, 0.2≦x≦0.5, 0.2≦y≦0.5, 0.2≦z≦0.4, 0≦b≦0.02, a+b+x+y+z=1).

As the negative electrode active material, a carbon material which can occlude and discharge lithium ions may be used. Carbon materials which can occlude and discharge lithium ions include graphite, a hardly graphitizing carbon, an easily graphitizing carbon, fiber carbon, cokes, and carbon black. Of these, the graphite is particularly preferable. As a non-carbon-based material, silicon, tin, and an alloy and an oxide having silicon and tin as primary constituent may be exemplified.

As the non-aqueous solvent (organic solvent) of the non-aqueous electrolyte, carbonates, lactones, ethers, ketones, esters, or the like may be used. Alternatively, two or more of these solvents may be used in a mixture. For example, ring carbonates such as ethylene carbonate, propylene carbonate, and butylene carbonate, or chain carbonates such as dimethyl carbonate, ethylmethyl carbonate, and diethyl carbonate may be used. In particular, the use of a mixture solvent of the ring carbonate and the chain carbonate is preferable. In addition, an unsaturated ring ester carbonate such as vinylene carbonate (VC) may be added to the non-aqueous electrolyte.

As electrolyte salts of the non-aqueous electrolyte, materials generally used as the electrolyte salt in the lithium ion secondary battery of the related art may be used. For example, LiPF₆, LiBF₄, LiCF₃SO₃, LiN(CF₃SO₂)₂, LiN(C₂F₅SO₂)₂, LiN(CF₃SO₂)(C₄F₉SO₂), LiC(CF₃SO₂)₃, LiC(C₂F₅SO₂)₃, LiAsF₆, LiClO₄, Li₂B₁₀Cl₁₀, Li₂B₁₂Cl₁₂, LiB(C₂O₄)₂, LiB(C₂O₄)F₂, LiP(C₂O₄)₃, LiP(C₂O₄)₂F₂, or LiP(C₂O₄)F₄, or a mixture thereof may be used. Of these, LiPF₆ is particularly preferable. In addition, the dissolved amount of the electrolyte salt in the non-aqueous solvent is preferably 0.5˜2.0 mol/L.

As the separator, a porous separator made of polyolefin may be preferably used such as polypropylene (PP) and polyethylene (PE). In particular, a separator having a 3-layer structure of polypropylene (PP) and polyethylene (PE) (PP/PE/PP or PE/PP/PE) is preferable. Alternatively, a polymer electrolyte may be used as the separator.

The flat-shaped electrode assembly may be a layered electrode assembly in which a plurality of positive electrode plates, a plurality of the negative electrode plates, and the separator are layered.

What is claimed is:

1. A non-aqueous electrolytic secondary battery comprising:
a flat-shaped electrode assembly having a positive electrode plate including a lithium transition metal complex oxide as a positive electrode active material, and a negative electrode plate including a negative electrode active material to and from which lithium ions may be introduced and extracted;
a non-aqueous electrolyte;
a rectangular outer housing that has a tubular shape with a bottom, that has an opening and that houses the electrode assembly and the non-aqueous electrolyte; and
a sealing plate that seals the opening, wherein
the non-aqueous electrolyte includes lithium fluorosulfonic acid,
the rectangular outer housing comprises a pair of large-area side walls and a pair of small-area side walls having a smaller area than the large-area side wall, and
a value of a number of layers of the positive electrode plate in the electrode assembly placed between the pair of the large-area side walls with respect to a distance between the pair of the large-area side walls is greater than or equal to 5 layers/mm.

2. The non-aqueous electrolytic secondary battery according to claim 1, wherein the electrode assembly is a winding electrode assembly in which the positive electrode plate and the negative electrode plate are wound with a separator therebetween.

3. The non-aqueous electrolytic secondary battery according to claim 1, wherein a ratio of a total thickness of the negative electrode plate in the electrode assembly placed between the pair of the large-area side walls with respect to a total thickness of the positive electrode plate in the electrode assembly placed between the pair of the large-area side walls is 100˜120%.

4. The non-aqueous electrolytic secondary battery according to claim 1, wherein a ratio of a total thickness of the separator in the electrode assembly placed between the pair of the large-area side walls with respect to a total thickness of the positive electrode plate in the electrode assembly placed between the pair of the large-area side walls is 65˜85%.
